(19) United States
(12) Patent Application Publication
(10) Pub. No.: US 2010/0123618 A1
(43) Pub. Date: May 20, 2010

(54) CLOSED LOOP PHASE CONTROL BETWEEN DISTANT POINTS

(75) Inventors: G. Patrick Martin, Merritt Island, FL (US); John Roach, Indialantic, FL (US); William C. Adams, JR., West Melbourne, FL (US); Kathleen Minear, Palm Bay, FL (US); Ronald J. Hash, Palm Bay, FL (US); Lynda Margaret Ralston, West Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: Harris Corporation, Melbourne, FL (US)

(21) Appl. No.: 12/273,839

(22) Filed: Nov. 19, 2008

(51) Int. Cl. G01S 7/40

(52) U.S. Cl. 342/174

(57) ABSTRACT

Methods for compensating for phase shifts of a communication signal. The methods involve determining a first reference signal (V_{ref-1}) at a first location along a transmission path and a second reference signal (V_{ref-2}) at a second location along the transmission path. V_{ref-2} is the same as V_{ref-1.} At the first location, a first phase offset is determined using V_{ref-1} and a first communication signal. At the second location, a second phase offset is determined using V_{ref-2} and a second communication signal. A phase of a third communication signal is adjusted at the second location using the first and second phase offsets to obtain a modified communication signal. The first, second, and third communication signals are the same communication signal obtained at different locations along the transmission path.

### BACKGROUND OF THE INVENTION

1. Statement of the Technical Field

The invention concerns communication systems. More particularly, the invention concerns communication systems and methods for controlling the phase between distant points using a closed loop configuration.

2. Description of the Related Art

Multiple element antenna arrays are widely used in wireless communications systems to enhance the transmission and reception of signals. In particular, the enhanced performance is generally provided by using such antenna arrays in conjunction with beamforming techniques. In conventional beamforming, the naturally occurring interference between the different antenna elements in the antenna array is typically used to change the overall directionality for the array. For example, during transmission, the phase and relative amplitude of the transmitted signal at each antenna element is adjusted, in order to create a desired pattern of constructive and destructive interferences at the wavefront of the transmitted signal. During signal reception, the different antenna elements are modified in phase and amplitude in such a way that a pre-defined pattern of radiation is preferentially observed by the antenna elements.

In general, such antenna arrays typically include a system controller, a plurality of antenna controllers, and a plurality of antenna elements (e.g., dish antennas). Each of the antenna elements is communicatively coupled to the system controller and a respective one of the antenna controllers via cables. During transmission and reception, each antenna element converts electrical signals into electromagnetic waves, and vice versa. The system controller, using conventional beamforming techniques, varies the configuration of the various components in the antenna array to provide a particular radiation pattern during transmission or reception. However, as the dimensions of the array, the number of antenna elements, and the precision required in certain beamforming application increase, properly concerting the actions of the various components becomes more difficult.

### SUMMARY OF THE INVENTION

Embodiments of the present invention concern methods for compensating for phase shifts of a communication signal. The methods involve determining a first reference signal at a first location along a transmission path and a second reference signal at a second location along the transmission path. The second reference signal is the same as the first reference signal. The methods also involve determining at the first location a first phase offset using the first reference signal and a first communication signal. A second phase offset is determined at the second location using the second reference signal and a second communication signal. A phase of a third communication signal is adjusted at the second location using the first and second phase offsets to obtain a modified communication signal. More particularly, a weight is computed at the second location using the first and second phase offsets. The weight is then combined with the third communication signal to obtain the modified communication signal. The first, second, and third communication signals are the same communication signal obtained at different locations along the transmission path.

According to an aspect of the invention, the first reference signal is determined by sensing at the first location a transmit signal propagated over a transmission media in a forward direction and a reverse signal propagated over the transmission media in a reverse direction opposed from the forward direction. The reverse signal being a reflected version of the transmit signal. A first sum signal is computed by adding the transmit and reverse signals together. A first difference signal is computed by subtracting the reverse signal from the transmit signal. Thereafter, a first exponentiation signal is determined using the first sum signal and a second exponentiation signal is determined using the first difference signal. The first exponentiation signal is subtracted from the second exponentiation signal to obtain the first reference signal. The first reference signal can have a first frequency equal to a second frequency of the transmit signal. Alternatively, the first reference signal can have a first frequency different than a second frequency of the transmit signal. In such a scenario, the first reference signal can be processed to obtain an adjusted reference signal with a third frequency equal to the second frequency of the transmit signal.

The second reference signal is determined by sensing at the second location the transmit and reverse signals. Thereafter, the second reference signal is determined using the transmit and reverse signals sensed at the second location. More particularly, the second reference signal is determined by computing a second sum signal by adding the transmit and reverse signals sensed at the second location together and a second difference signal by subtracting the reverse signal sensed at the second location from the transmit signal sensed at the second location. A third exponentiation signal is determined using the second sum signal and a fourth exponentiation signal using the second difference signal. The third exponentiation signal is subtracted from the fourth exponentiation signal to obtain the second reference signal.

Embodiments of the present invention also relate to methods for compensating for phase shifts of received communication signals. The methods generally involve determining a third reference signal at a third location along the transmission path and a fourth reference signal at a fourth location along the transmission path. At the third location, the communication signal is combined with the third reference signal to obtain a modified received communication signal. At the fourth location, a third phase offset is determined using the modified received communication signal and the fourth reference signal. Thereafter, a phase of the modified received communication signal is adjusted using the third phase offset to obtain a phase adjusted received signal.

Embodiments of the present invention further relate to systems implementing at least one of the above described methods. The systems generally include at least one reference signal generator and at least one closed loop operator communicatively coupled to the reference signal generator. The reference signal generator is configured for determining the first reference signal at the first location along a transmission path and the second reference signal at the second location along the transmission path. The closed loop operator is configured for determining at the first location the first phase offset using the first reference signal and the first communication signal. The closed loop operator is also configured for determining at the second location the second phase offset using the second reference signal and the second communication signal. The closed loop operator is further configured for adjusting at the first location the phase of a third communication signal using the first and second phase offsets to obtain the modified communication signal.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary communications system configured according to an embodiment of the present invention.

FIG. 2 is a block diagram of the antenna control system shown in FIG. 1.

FIG. 3 is a block diagram of the transmit side of the antenna control system shown in FIGS. 1-2 communicatively coupled to the RF equipment shown in FIG. 1.

FIG. 4 is a more detailed block diagram of the phase comparator of FIG. 3.

FIG. 5 is a block diagram of the receive side of the antenna control system shown in FIGS. 1-2 communicatively coupled to the RF equipment shown in FIG. 1.

FIG. 6A is a more detailed block diagram of the communication system of FIG. 1 that is useful for understanding the phase and/or amplitude adjustment functions thereof.

FIG. 6B is a more detailed block diagram of the communication system of FIG. 1 that is useful for understanding the phase and/or amplitude adjustment functions thereof.

FIG. 7 is a more detailed block diagram of the communication system of FIG. 1 that is useful for understanding the phase and/or amplitude adjustment functions thereof.

FIG. 8 is a schematic view of a computer system within which a set of instructions operate according to an embodiment of the present invention.

FIG. 9 is a block diagram of a communication system that is useful for understanding how a reference signal is determined.

FIG. 10 is a conceptual diagram of a first method embodiment for determining a reference signal that is useful for understanding the present invention.

FIG. 11 is a conceptual diagram of a second method embodiment for determining a reference signal that is useful for understanding the present invention.

FIG. 12 is a block diagram of a first system embodiment implementing a method of FIGS. 10 and 11.

FIG. 13 is a block diagram of a second system embodiment implementing the method of FIG. 10.

FIG. 14 is a block diagram of a third system embodiment implementing the method of FIG. 10.

### DETAILED DESCRIPTION

The present invention is described with reference to the attached figures, wherein like reference numbers are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

In conventional multi-beam antenna systems, the phases of the signals to be transmitted from the antenna elements can be shifted as a result of environmental effects on hardware components of the system including the antenna, Radio Frequency (RF) components and the cables connecting the antenna elements to the controllers. These phase shifts typically result in the steering of the radiated main beam in the wrong direction.

To overcome the various limitations of the conventional multi-beam antenna systems, embodiments of the present invention provide systems implementing an improved beam forming solution. The improved beam forming solution is facilitated by novel methods for determining a reference signal at any location along a transmission media. The methods generally involve determining a first reference signal at a first location along a transmission path and a second reference signal at a second location along the transmission path. The second reference signal must be substantially the same as the first reference signal. At the first location, the first reference signal is combined with a communications signal to obtain a first phase adjusted signal. At the second location, a phase offset is determined using the second reference signal and the first phase adjusted signal. The phase of the first phase adjusted signal is subsequently adjusted using the phase offset to obtain a modified communications signal.

Before describing the systems and methods of the present invention, it will be helpful in understanding an exemplary environment in which the invention can be utilized. In this regard, it should be understood that the systems and methods of the present invention can be utilized in a variety of different applications where phases of transmit signals need to be adjusted so as to counteract the environmental effects on hardware components of communication systems. Such applications include, but are not limited to, mobile/cellular telephone applications, military communication applications, and space communication applications. Accordingly, the present invention will be described in relation to space communication applications.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

### Communication System Architecture

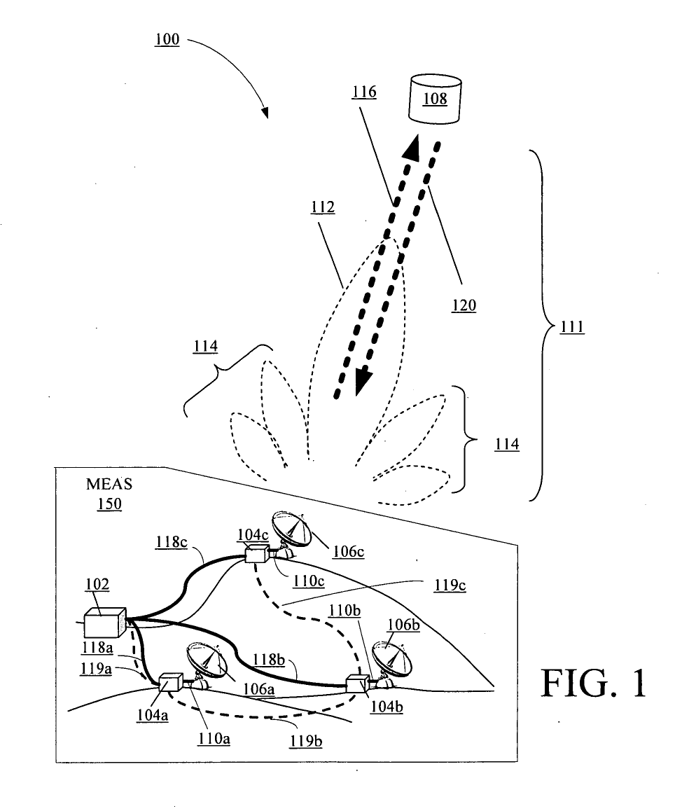

FIG. 1 shows an exemplary communication system 100 according to an embodiment of the present invention. As shown in FIG. 1, the communication system 100 comprises a multi-element antenna system (MEAS) 150 for transmitting signals to and receiving signals from at least one object of interest 108 remotely located from the MEAS 150. In FIG. 1, the object of interest 108 is shown as an airborne or spaceborne object, such as an aircraft, a spacecraft, a natural or artificial satellite, or a celestial object (e.g., a planet, a moon, an asteroid, a comet, etc. . . . ). However, embodiments of the present invention are not limited in this regard. The MEAS 150 can also be used for transmitting and receiving signals from objects of interest 108 that are not airborne or spaceborne but are still remotely located with respect to MEAS 150. For example, a ground-based MEAS 150 can be used to provide communications with objects of interest 108 at other ground-based or sea-based locations.

In FIG. 1, the ACS 102 is shown as controlling the operation of antenna elements 106a, 106b, 106c and associated RF equipment 104a, 104b, 104c. The antenna elements 106a, 106b, 106c provide wireless communications. For example, if the MEAS 150 is in a transmit mode, then each antenna element 106a, 106b, 106c converts electrical signals into electromagnetic waves. The radiation pattern 111 resulting from the interference of the electromagnetic waves transmitted by the different antenna elements 106a, 106b, 106c can then be adjusted to a central beam 112 in the radiation pattern 111 aimed in the direction 116 of the object of interest 108. The radiation pattern 111 of the antenna elements 106a, 106b, 106c also generates smaller side beams (or side lobes) 114 pointing in other directions with respect to the direction of the central beam 112. However, because of the relative difference in magnitude between the side beams 114 and the central beam 112, the radiation pattern 111 preferentially transmits the signal in the direction of the central beam 112. Therefore, by varying the phases and the amplitudes of the signals transmitted by each antenna element 106a, 106b, 106c, the magnitude and direction of the central beam 112 can be adjusted. If the MEAS 150 is in a receive mode, then each of the antenna elements 106a, 106b, 106c captures energy from passing waves propagated over transmission media (not shown) in the direction 120 and converts the captured energy to electrical signals. In the receive mode, the MEAS 150 can be configured to combine the electrical signals according to the radiation pattern 111 to improve reception from direction 120, as described below.

In FIG. 1, the antenna elements 106a, 106b, 106c are shown as reflector-type (e.g., a dish) antenna elements, which generally allow adjustment of azimuth (or rotation) and elevation (angle with respect to a ground plane). Therefore, in addition to adjustment of phase and amplitude of the signal transmitted by each of the antenna elements 106a, 106b, 106c, the azimuth and elevation of each antenna element 106a, 106b, 106c can also be used to further steer the central beam 112 and adjust the radiation pattern 111. However, embodiments of the present invention are not limited on this regard. The antenna elements 106a, 106b, 106c can comprise directional or omni-directional antenna elements.

Although three (3) antenna elements 106a, 106b, 106c are shown in FIG. 1, the various embodiments of the present invention are not limited in this regard. Any number of antenna elements 106a, 106b, 106c can be used without limitation. Furthermore, the spacing between the antenna elements 106a, 106b, 106c with respect to each other is not limited. Accordingly, the antenna elements 106a, 106b, 106c can be widely spaced or closely spaced. However, as the spacing between the antenna elements 106a, 106b, 106c increases, the central beam 112 generally becomes narrower and the side beams (or side lobes) 114 generally become larger. The antenna elements 106a, 106b, 106c can also be regularly spaced (not shown) with respect to one another or arbitrarily spaced (or non-linearly spaced) with respect to one another (as shown in FIG. 1) to form a three dimensional (3D) array of antenna elements. As shown in FIG. 1, the arbitrary spacing of the antenna elements 106a, 106b, 106c can include locations having different altitudes and locations having different distances between each other.

As shown in FIG. 1, each of the antenna elements 106a, 106b, 106c is communicatively coupled to a respective RF equipment 104a, 104b, 104c via a respective cable assembly 110a, 110b, 110c (collectively 110). Each of the cable assemblies 110a, 110b, 110c can have the same or different lengths. As used herein, the phrase “cable assembly” refers to any number of cables provided or interconnecting two different components. In the various embodiments of the present invention, the cables in the cable assemblies 110a, 110b, 110c can be bundled or unbundled.

Notably, the cables 110a, 110b, 110c can delay transmit signals. In effect, the phases of the transmit signals can be shifted thereby resulting in phasing errors. As such, the communication system 100 implements a closed loop method to counteract phasing errors due to cable delay effects. The closed loop method will become more evident as the discussion progresses.

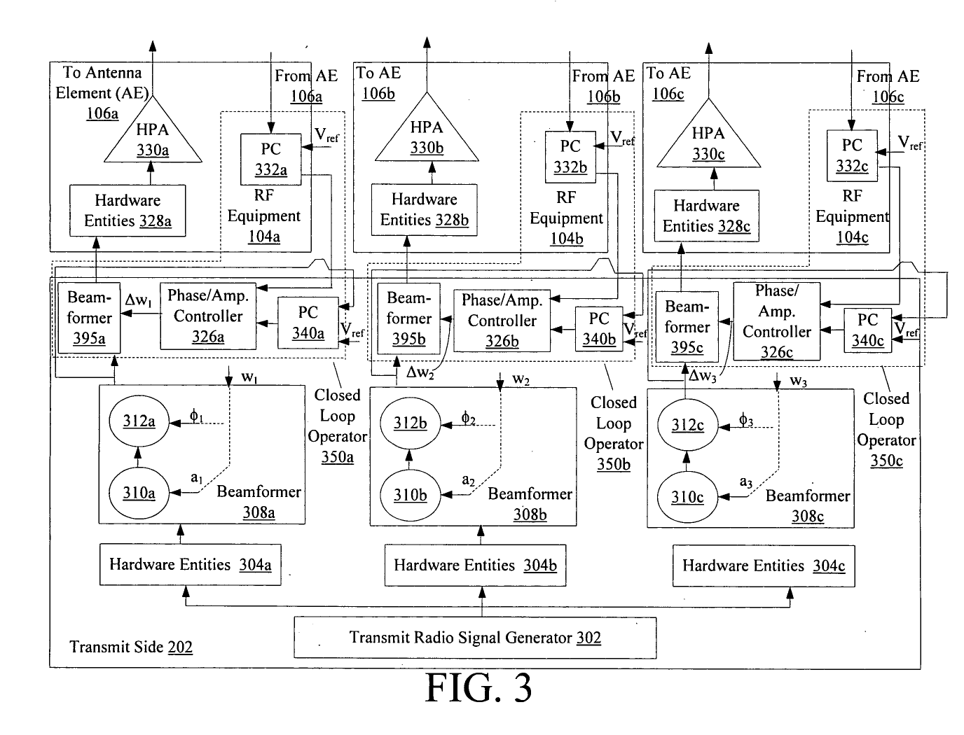

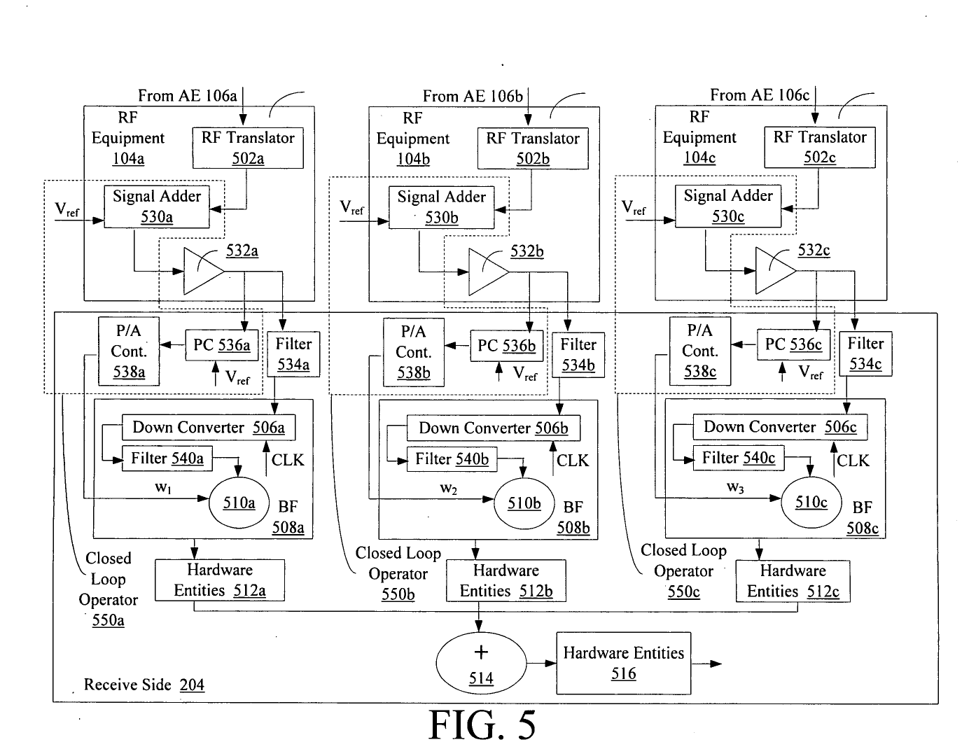

The RF equipment 104a, 104b, 104c control the antenna elements 106a, 106b, 106c, respectively. For example, for the directional antenna elements 106a, 106b, 106c shown in FIG. 1, the RF equipment 104a, 104b, 104c are configured to control antenna motors (not shown), antenna servo motors (not shown), and antenna rotators (not shown). The RF equipment 104a, 104b, 104c can also include hardware entities for processing transmit signals and receive signals. Notably, the phases of transmit signals can be shifted as a result of environmental effects on the cabling, antenna, and/or RF equipment 104a, 104b, 104c. These phase shifts can result in the steering of the radiated central beam 112 in a direction other than the direction 116 of the object of interest 108. The RF equipment 104a, 104b, 104c will be described in more detail below in relation to FIGS. 3 and 5.

As shown in FIG. 1, each of the RF equipment 104a, 104b, 104c is communicatively coupled to the ACS 102 via a respective communications link 118a, 118b, 118c. Generally, such communications links are provided via a cable assembly. However, embodiments of the present invention are not limited in this regard. In the various embodiments of the present invention, the communications links 118a, 118b, 118c can comprise wireline, optical, or wireless communication links. The cable assemblies for the communications links 118a, 118b, 118c can have the same or different lengths. Although the communications links 118a, 118b, 118c are shown to couple the RF equipment 104a, 104b, 104c to the ACS 102 in parallel, embodiments of the present invention are not limited in this regard. The RF equipment 104a, 104b, 104c can also be coupled to the ACS 102 in a series arrangement, such as that shown by communication links 119a, 119b, 119c.

Notably, the cable assemblies of the communication links 118a, 118b, 118c, 119a, 119b, 119c can delay transmit signals. In effect, the phases of the transmit signals can be shifted thereby resulting in phasing errors. As such, the communication system 100 implements a closed loop method to counteract phasing errors due to cable delay effects. The closed loop method will become more evident as the discussion progresses.

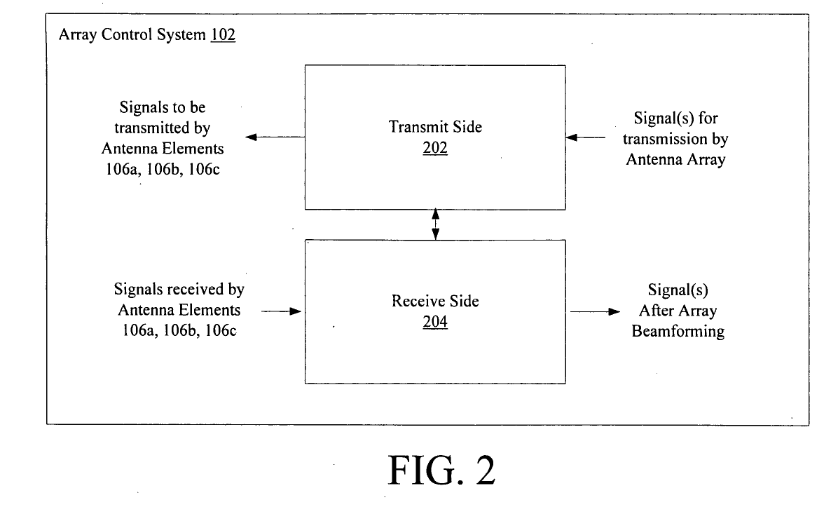

In operation, the ACS 102 modulates signals to be transmitted by the antenna elements 106a, 106b, 106c. The ACS 102 also demodulates signals received after beamforming. The ACS 102 further controls beam steering. Notably, the interconnecting cables and/or elements can be affected by surrounding environmental conditions (e.g., heat). Such phase shifts can result in the steering of the radiated central beam 112 in a direction other than the direction 116 of the object of interest 108. As such, the communication system 100 implements a closed loop method to counteract phasing errors due to environmental effects on ACS 102. The closed loop method will become more evident as the discussion progresses. The ACS 102 will be described in more detail below in relation to FIGS. 2-3 and 5.

Referring now to FIG. 2, there is provided a block diagram of the ACS 102 shown in FIG. 1. As shown in FIG. 2, the ACS 102 includes a transmit side 202 and a receive side 204. Furthermore, the ACS 102 is configured to manage both transmission and reception operations of the MEAS 150 based on signals for transmission and control signals. In particular, the transmit side 202 can generate signals to be transmitted by the antenna elements 106a, 106b, 106c. Additionally or alternatively, the transmit side 202 can receive one or more signals from one or more signal generators (not shown). The transmit side 202 is also configured for modulating each of the generated or received signals and communicating the modulated signals to the RF equipment 104a, 104b, 104c for transmission of the same over a transmission media (not shown). The transmit side 202 will be described in more detail below in relation to FIG. 3.

The receive side 204 is configured for receiving signals received by the transmission elements. The receive side 204 is also configured for demodulating the electrical signal and communicating the demodulated electrical signal to an output device (not shown). The receive side 204 will be described below in more detail in relation to FIG. 5.

Although the transmit side 202 and receive side 204 can operate separately or independently in some embodiments of the present invention, in other embodiments, operation of the transmit side 202 can be further adjusted based on one or more signals generated in the receiver side 204 of the ACS 102, as shown in FIG. 2.

Referring now to FIG. 3, there is provided a block diagram of the transmit side 202 of FIG. 2 communicatively coupled to the RF equipment 104a, 104b, 104c of FIG. 1. As shown in FIG. 3, the transmit side 202 is comprised of a Transmit Radio Signal Generator (TRSG) 302, hardware entities 304a, 304b, 304c, beamformers 308a, 308b, 308c, 395a, 395b, 395c, phase/amplitude controllers 326a, 326b, 326c, and phase comparators 340a, 340b, 340c. Each RF equipment 104a, 104b, 104c comprises hardware entities 328a, 328b, 328c, high power amplifiers (HPAs) 330a, 330b, 330c, and phase comparators 332a, 332b, 332c.

The TRSG 302 of the transmit side 202 can generate signals to be transmitted from the array of antenna elements 106a, 106b, 106c. The TRSG 302 is communicatively coupled to the hardware entities 304a, 304b, 304c. The phrase “hardware entities”, as used herein, refers to signal processing devices, including but not limited to, filters and amplifiers. Each of the hardware entities 304a, 304b, 304c is communicatively coupled to a respective one of the beamformers 308a, 308b, 308c.

Each of the beamformers 308a, 308b, 308c can be utilized to control the phase and/or the amplitude of transmit signals. In general, the phase and/or amplitude of the transmit signal can be used to adjust formation of the central beam 112, the side beams (or side lobes) 114, and nulls in the radiation pattern 111. Nulls correspond to directions in which destructive interference results in a transmit signal's strength that is significantly reduced with respect to the directions of the central beam 112 and the side beams 114. The combined amplitude a₁, a₂, a₃ and phase shift φ₁, φ₂, φ₃ is referred to herein as a complex weight w₁, w₂, w₃, respectively. Each of the beamformers 308a, 308b, 308c combines a respective complex weight w₁, w₂, w₃ with the transmit signals to be provided to a respective RF equipment 104a, 104b, 104c. For example, as shown in FIG. 3, each beamformer 308a, 308b, 308c includes a respective amplitude adjuster 310a, 310b, 310c for adjusting the amplitude of the transmit signals from respective hardware entities 304a, 304b, 304c based on an amplitude a₁, a₂, a₃. Each beamformer 308a, 308b, 308c includes a respective phase adjuster 312a, 312b, 312c for adjusting the phases of transmit signals from respective hardware entities 304a, 304b, 304c based on a phase shift φ₁, φ₂, φ₃.

Each beamformer 308a, 308b, 308c is communicatively coupled to a respective closed loop operator 350a, 350b, 350c. The closed loop operators 350a, 350b, 350c will be described below. However, it should be understood that the closed loop operators 350a, 350b, 350c are generally configured to adjust the phase and/or amplitude of transmit signals and communicate the phase and/or amplitude adjusted transmit signals to the hardware entity 328a, 328b, 328c of the RF equipment 104a, 104b, 104c. The hardware entities 328a, 328b, 328c are communicatively coupled to a respective HPA 330a, 330b, 330c. HPAs are well known to those having ordinary skill in the art, and therefore will not be described herein. However, it should be understood that the HPAs 330a, 330b, 330c communicate signals to the antenna elements 106a, 106b, 106c for transmission therefrom in the direction 116 of an object of interest 108.

Each closed loop operator 350a, 350b, 350c is generally configured for controlling the phases and/or amplitudes of transmit signals so as to counteract phasing errors due to cable delay effects, wide antenna spacing effects, and environmental effects on hardware components 102, 104a, 104b, 104c of a communication system 100. Accordingly, each closed loop operator 350a, 350b, 350c includes a phase comparator 332a, 332b, 332c, a phase comparator 340a, 340b, 340c, a phase/amplitude controller 326a, 326b, 326c, and a beamformer 395a, 395b, 396c.

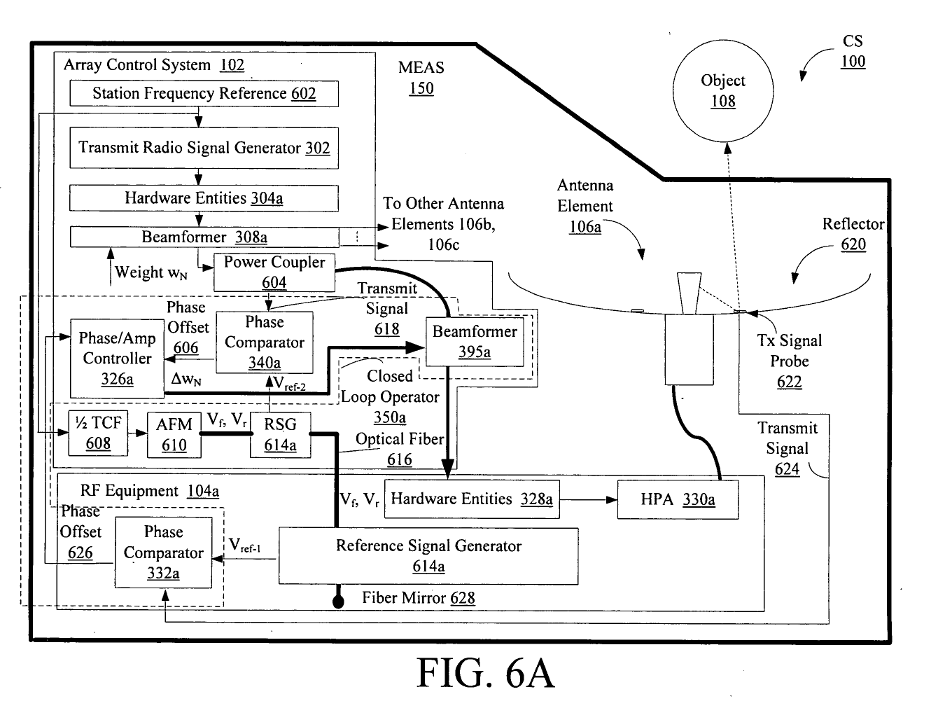

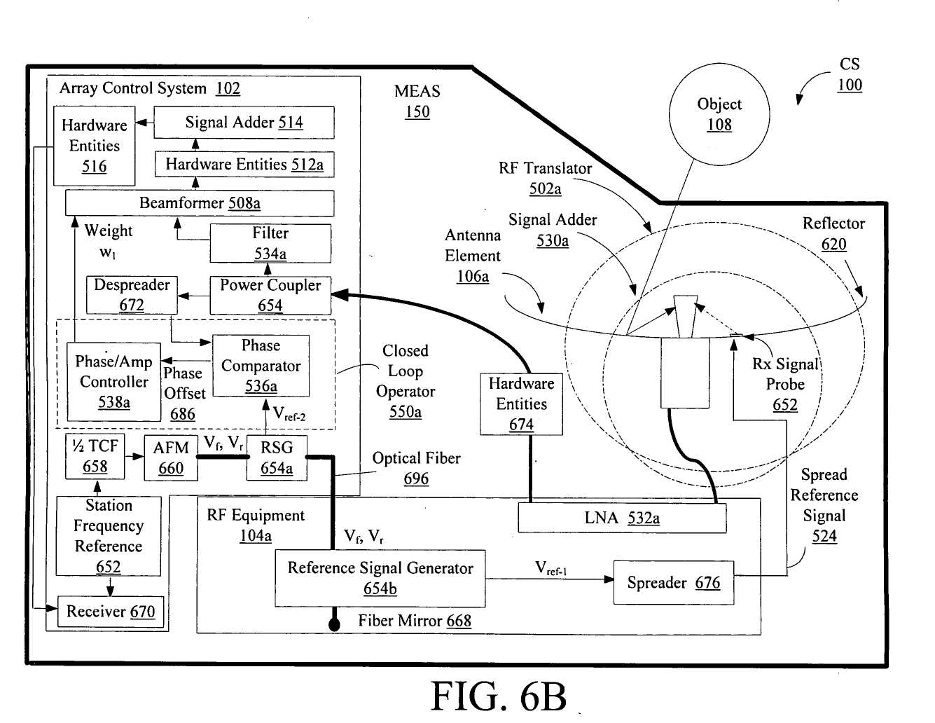

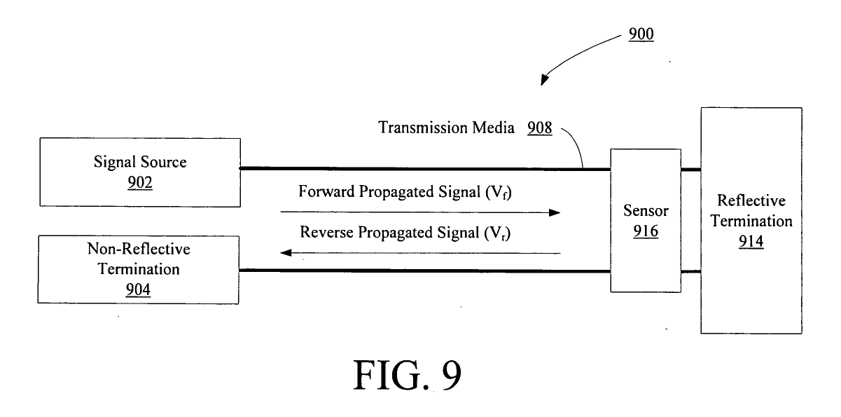

The phase comparator 332a, 332b, 332c is configured to receive a transmit signal from the antenna element 106a and a reference signal V_{ref} from a first reference signal generator (not shown). In this regard, it should be understood that each of the antenna elements 106a, 106b, 106c has a transmit (Tx) signal sensor disposed thereon for sensing the transmit signal. Each of the antenna elements 106a, 106b, 106c also has a reference radiator disposed thereon for sensing a receive signal. A schematic illustration of the antenna element 106a having a transmit (Tx) signal sensor 608 positioned on its reflector 604 is provided in FIG. 6. It should be noted that a sensing location on the reflector 604 enables signal path phase compensation over a maximum extent of components subject to variation. However in some applications, the sensing location may, for operational convenience, reside instead within the feed or on a transmission line leading to the feed. The result of such a sensing location is the exclusion of the omitted components from closed loop phase compensation. The first reference signal generator (not shown) and the manner in which the reference signal V_{ref} is determined will be described below in relation to FIGS. 9-14.

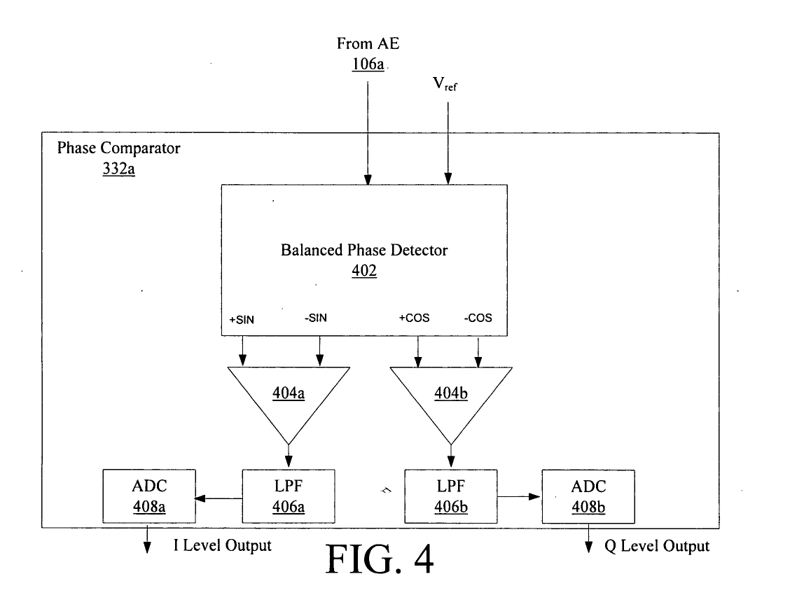

Subsequent to receiving the transmit signal and the reference signal V_{ref}, the phase comparator 332a, 332b, 332c performs a comparison operation to determine a phase offset between the signals. The phase offset can be represented in terms of an imaginary part Q and a real part I. After determining the phase offset, the phase comparator 332a, 332b, 332c communicates the phase offset value(s) to the phase/amplitude controller 326a, 326b, 326c. The phase comparators 332a, 332b, 332c will be described in more detail below in relation to FIG. 4.

The phase comparator 340a, 340b, 340c is configured to receive a transmit signal from the beamformer 308a, 308b, 308c. The phase comparator 340a, 340b, 340c is also configured to receive a reference signal V_{ref} from a second reference signal generator (not shown). The manner in which the reference signal V_{ref} is determined will be described below in relation to FIGS. 9-14.

The second reference signal generator (not shown) is the same as or substantially similar to the first reference signal generator (not shown) that provided the reference signal V_{ref} to the phase comparator 332a, 332b, 332c. However, the first and second signal generators (not shown) are positioned at different locations within the communication system 100. For example, the first signal generator (not shown) can reside in the RF equipment 104a, 104b, 104c. In contrast, the second signal generator (not shown) can reside in the transmit side 202 of the ACS 102. The first and second reference signal generators (not shown) will be described below in relation to FIGS. 9-14.

After receiving the transmit signal and the reference signal V_{ref}, the phase comparator 340a, 340b, 340c performs a comparison operation to determine a phase offset between the signals. The phase offset can be represented in terms of an imaginary part Q and a real part I. The phase comparators 340a, 340b, 340c will be described in more detail below in relation to FIG. 4.

The phase/amplitude controller 326a, 326b, 326c determines a phase and/or amplitude adjustment value Δw₁, Δw₂, Δw₃ that is to be used by a beamformer 395a, 395b, 395c to control the phase and/or amplitude of transmit signals. The phase and/or amplitude adjustment value Δw₁, Δw₂, Δw₃ is determined using the phase offset values received from the phase comparators 332a, 332b, 332c, 340a, 340b, 340c.

Referring now to FIG. 4, there is provided a detailed block diagram of the phase comparator 332a. Each of the phase comparators 332b, 332c, 340a, 340b, 340c is the same as or substantially similar to the phase comparator 332a. As such, the following description of the phase comparator 332a is sufficient for understanding the phase comparators 332b, 332c, 340a, 340b, 340c.

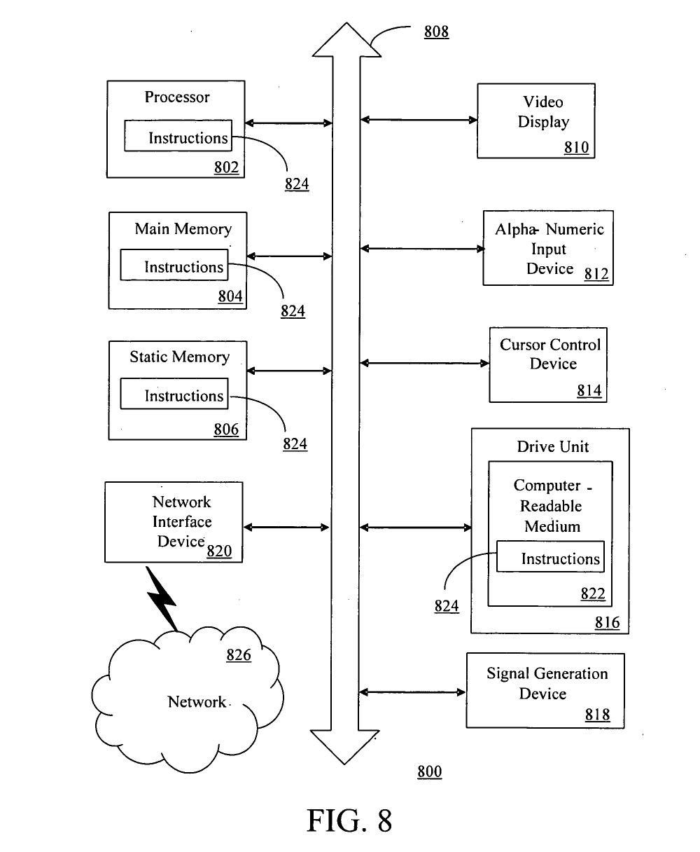

As shown in FIG. 4, the phase comparator 332a comprises a balanced phase detector 402, operational amplifiers (or comparators) 404a, 404b, low power filters (LPFs) 406a, 406b, and analog to digital converters (ADC) 408a, 408b. The balanced phase detector 402 is configured to receive a transmit signal from the antenna element 106a and a reference signal V_{ref} from a reference signal generator (not shown in FIG. 4 and will be described below in relation to FIGS. 8-13). The balanced phase detector 402 is also configured to generate a +SIN output, a −SIN output, a +COS output, and a −COS output using the received signals. The SIN outputs represent the real parts I of the phases of the signals. In contrast, the COS outputs represent the imaginary parts Q of the phases of the signals. The SIN outputs are communicated from the balanced phase detector 402 to the operational amplifier (or comparator) 404a. Similarly, the COS outputs are communicated from the balanced phase detector 402 to the operational amplifier (or comparator) 404b.

Operational amplifiers (or comparators) are well known to those having ordinary skill in the art, and therefore will not be described herein. However, it should be understood that each of the operational amplifiers (or comparators) 404a, 404b compares the values of the signals received from the balanced phase detector 402. Each of the operational amplifiers (or comparators) 404a, 404b also outputs an analog signal and communicates the same to the LPFs 406a, 406b, respectively. After performing filtering operations, the LPFs 406a, 406b forward the filtered analog signals to the ADCs 408a, 408b. The ADCs 408a, 408b convert the filtered analog signals to digital signals. The output of ADC 408a represents a real part I of a phase offset value. The output of ADC 408b represents an imaginary part Q of the phase offset value.

Referring now to FIG. 5, there is provided a block diagram of the receive side 204 of FIG. 2 communicatively coupled to the RF equipment 104a, 104b, 104c of FIG. 1. As shown in FIG. 5, each of the RF equipment 104a, 104b, 104c further comprises a Radio Frequency (RF) translator 502a, 502b, 502c, a Low Noise Amplifier (LNA) 532a, 532b, 532c, and a portion of a closed loop operator 550a, 550b, 550c. The portion of a closed loop operator 550a, 550b, 550c includes a signal adder 530a, 530b, 530c. Each of the RF translators 502a, 502b, 502c performs signal frequency translation of received signals from a respective antenna element 106a, 106b, 106c in the respective RF equipment 104a, 104b, 104c. The translation function of the RF translators 502a, 502b, 502c generally converts the received signal at a respective antenna element 106a, 106b, 106c from an RF to an intermediate frequency (IF). The RF translators 502a, 502b, 502c communicate the IF signals to the signal adders 530a, 530b, 530c, respectively.

At the signal adders 530a, 530b, 530c, the IF signals are combined with a reference signal V_{ref} or a spread reference signal (not shown) generated using the reference signal V_{ref}. The reference signals V_{ref} can be generated by reference signal generators (not shown). The reference signal generator (not shown) will be described below in relation to FIGS. 8-13. The combined signals (or spread spectrum signals) formed at the signal adders 530a, 530b, 530c are then communicated to the LNAs 532a, 532b, 532c, respectively. The LNAs 532a, 532b, 532c generally amplify the IF signals output from the RF translators 502a, 502b, 502c, respectively. Each of the LNAs 532a, 532b, 532c is communicatively coupled to the receive side 204 of the ACS 102.

As shown in FIG. 5, the receive side 204 comprises a plurality of filters 534a, 534b, 534c, portions of the closed loop operators 550a, 550b, 550c, a plurality of beamformers 508a, 508b, 508c, hardware entities 512a, 512b, 512c, 516, and a signal combiner 514. Embodiments of the present invention are not limited in this regard. For example, the receive side 204 can be absent of the filters 534a, 534b, 534c and hardware entities 512a, 512b, 512c, 516.

As shown in FIG. 5, the filters 534a, 534b, 534c are communicatively coupled between the LNAs 532a, 532b, 532c and beamformers 508a, 508b, 508c. Each of the beamformers 508a, 508b, 508c can generally include a down converter 506a, 506b, 506c, a filter 540a, 540b, 540c, and a combiner 510a, 510b, 510c. Embodiments of the present invention are not limited in this regard. For example, the beamformers 508a, 508b, 508c can be absent of the down converters 506a, 506b, 506c and filters 540a, 540b, 540c.

Each down converter 506a, 506b, 506c converts a digitized real signal centered at an IF to a baseband complex signal centered at zero (0) frequency. The down converters 506a, 506b, 506c share a common clock (not shown), and therefore receive the same clock (CLK) signal. The CLK signal can be generated within the receive side 204, elsewhere in the ACS 102, or external to the ACS 102. The down converters 506a, 506b, 506c can be set to the same center frequency and bandwidth. The down converters 506a, 506b, 506c can also comprise local oscillators that are in-phase with each other. This in-phase feature of the down converters 506a, 506b, 506c ensures that the down converters 506a, 506b, 506c shift the phases of signals by the same amount. After converting the digitized real signals to baseband complex signals, the down converters 506a, 506b, 506c communicate the baseband complex signals to the filters 540a, 540b, 540c, respectively. The filters 540a, 540b, 540c filter the baseband complex signals and forward the same to the combiners 510a, 510b, 510c.

Each of the combiners 510a, 510b, 510c combines a baseband complex signal with a complex weight w₁, w₂, w₃ for a particular antenna element 106a, 106b, 106c. The complex weights w₁, w₂, w₃ are selected to combine the receive signals according to a particular radiation pattern 111. That is, the complex weights w₁, w₂, w₃ are selected to provide a central beam 112, side beams 114, and nulls, as described above, so as to preferentially receive signals from one or more predefined directions. The values of the complex weights w₁, w₂, w₃ are controlled by closed loop operators 550a, 550b, 550c. The closed loop operators 550a, 550b, 550c will be described below.

The combiners 510a, 510b, 510c can include, but are not limited to, complex multipliers. Thereafter, the combiners 510a, 510b, 510c communicate the signals to the hardware entities 512a, 512b, 512c, respectively. The hardware entities 512a, 512b, 512c can further process the signals received from the beamformers 508a, 508b, 508c. The hardware entities 512a, 512b, 512c communicate the processed signals to the signal combiner 514.

At the signal combiner 514, the processed signals are combined to form a combined signal. The signal combiner 514 can include, but is not limited to, a signal adder as shown in FIG. 5. Subsequent to forming the combined signal, the signal combiner 514 communicates the same to the hardware entities 516 for further processing. After processing the combined signal, the hardware entities 516 can communicate the same to a demodulator (not shown) for demodulation.

Each closed loop operator 550a, 550b, 550c is generally configured for controlling the phase and/or amplitude of receive signals so as to counteract phasing errors due to cable delay effects, wide antenna spacing effects, and environmental effects on hardware components 102, 104a, 104b, 104c of a communication system 100. Accordingly, each closed loop operator 550a, 550b, 550c includes a signal adder 530a, 530b, 530c, a phase comparator 536a, 536b, 536c, and the phase/amplitude controller 328a, 328b, 328c. The phase comparator 536a, 536b, 536c is configured to receive a received signal from the respective LNA 532a, 532b, 532c and a reference signal V_{ref} from a reference signal generator (not shown) located at the RF equipment 104a, 104b, 104c. The reference signal generator (not shown) will be described below in relation to FIGS. 9-14. Subsequent to receiving the signals, the phase comparator 536a, 536b, 536c performs a comparison operation to determine a phase offset between the signals. The phase offset can be represented in terms of an imaginary part Q and a real part I.

After determining the phase offset, the phase comparator 536a, 536b, 536c communicates the phase offset value(s) to the phase/amplitude controller 538a, 538b, 538c. The phase/amplitude controller 538a, 538b, 538c determines a complex weight w₁, w₂, w₃ that is to be used by a beamformer 508a, 508b, 508c to control the phase and/or amplitude of receive signals. The complex weight w₁, w₂, w₃ is determined using the received phase offset value(s) and a reference signal V_{ref} received from a reference signal generator (not shown). More particularly, the phase/amplitude controller 538a, 538b, 538c adjusts complex weights using the phase offset values. The reference signal generator (not shown) will be described below in relation to FIGS. 9-14.

Referring now to FIGS. 6A-6B, there are provided more detailed block diagrams of the communication system 100 that are useful for understanding the phase and/or amplitude adjustment functions thereof. The phase and/or amplitude adjustments functions of the transmit side 202 will be described below in relation to FIG. 6A. The phase and/or amplitude adjustments functions of the receive side 204 will be described below in relation to FIG. 6B. Notably, the antenna elements 106b, 106c and RF equipment 104b, 104c are not shown in FIGS. 6A-6B to simplify the following discussion. However, it should be understood that the antenna elements 106b, 106c are the same as or substantially similar to the antenna element 106a. Similarly, the RF equipment 104b, 104c is the same as or substantially similar to the RF equipment 104a.

As shown in FIG. 6A, the ACS 102 comprises a station frequency reference 602, the TRSG 302, hardware entities 304a, beamformers 308a, 395a, a power coupler 604, the phase/amplitude controller 326a, the phase comparator 340a, and a reference signal generator 614a. As also shown in FIG. 6A, the RF equipment 104a comprises hardware entities 328a, the HPA 330a, the phase comparator 332a, and a reference signal generator 614b. As further shown in FIG. 6A, the MEAS 150 comprises a ½ transmit carrier frequency device 608, an analog fiber modulator 610, an optical fiber 616, and a fiber mirror 628.

The TRSG 302 of the ACS 102 can generate signals to be transmitted from the antenna elements 106a, 106b (not shown), 106c (not shown). The TRSG 302 is communicatively coupled to the station frequency reference 602 and the hardware entities 304a. The hardware entities 304a are communicatively coupled to the beamformer 308a.

As noted above in relation to FIG. 3, the beamformer 308a can be utilized to control the phases and/or the amplitudes of transmit signals. Accordingly, the beamformer 308a combines a complex weight w_{N} with transmit signals to be provided to the RF equipment 904a, 904b (not shown), 904c (not shown). The beamformer 308a is communicatively coupled to power coupler 604. The power coupler 604 is communicatively coupled to the closed loop operator 350a. The closed loop operator 350a will be described below. However, it should be understood that the closed loop operator 350a is generally configured to adjust the phase and/or amplitude of transmit signals. The closed loop operator 350a is also configured to communicate the phase and/or amplitude adjusted transit signals to the hardware entities 328a of the RF equipment 104a. The hardware entities 328a are communicatively coupled to the HPA 330a. The HPA 330a communicates processed signals to the antenna element 106a for transmission therefrom.

The closed loop operator 350a is generally configured for controlling the phases and/or amplitudes of transmit signals so as to counteract phasing errors due to cable delay effects, wide antenna spacing effects, and environmental effects on hardware components 102 and 104a of the communication system 100. Accordingly, the closed loop operator 350a includes phase comparators 340a, 332a, a phase/amplitude controller 326a, and a beamformer 395a.

The phase comparator 332a is configured to receive a transmit signal 624 from the antenna element 106a and a reference signal V_{ref-1} from a reference signal generator 614b. In this regard, it should be understood that the antenna element 106a has a transmit (Tx) signal probe 622 disposed on its reflector 620 for sensing the transmit signal 624. In order to avoid the introduction of phase offsets into transmit signals, the communication path between the Tx signal probe 622 and the phase comparator 332a can be minimized. At the phase comparator 332a, the phase of the sensed transmit signal 624 is compared with the phase of the reference signal V_{ref-1} to determine a phase offset 626. The phase offset 626 can be represented in terms of an imaginary part Q and a real part I. The phase offset 626 is then communicated from the phase comparator 332a to the phase/amplitude controller 326a.

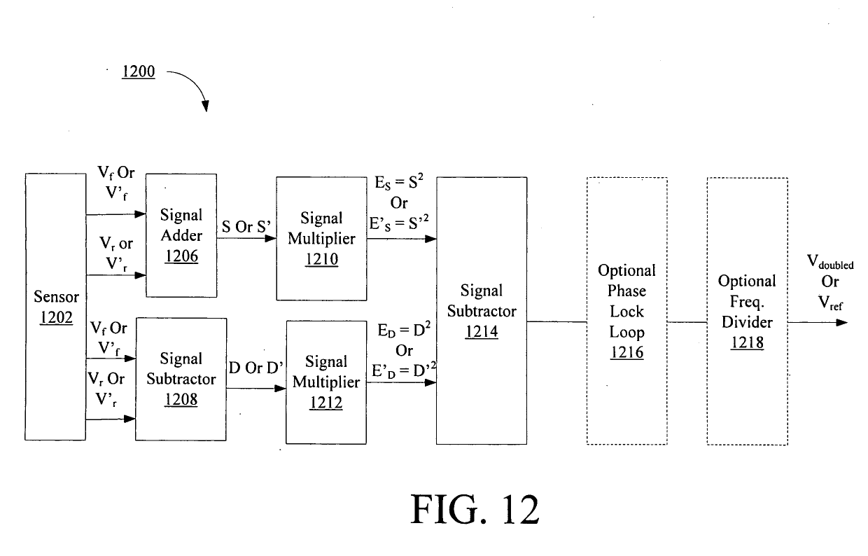

The reference signal V_{ref-1} utilized by the phase comparator 332a is generated by the reference signal generator 614b. The reference signal generator 614b is configured to receive sensed signals V_{f}, Vᵣ from one or more sensor devices (not shown) disposed on the optical fiber 616 at a first location. Additionally or alternatively, the reference signal generator 614b is configured to sense signals V_{f}, Vᵣ propagated along the optical fiber 616. The sensed signals V_{f}, Vᵣ are used to determine the reference signal V_{ref-1}. The manner in which the reference signal V_{ref-1} is determined will be described below in relation to FIGS. 9-11. The reference signal generator 614b can be the same as or substantially similar to any one of the reference signal generators described below in relation to FIGS. 12-14.

The phase comparator 340a is configured to receive a transmit signal 618 from the power coupler 604 and a reference signal V_{ref-2} from a reference signal generator 614a. At the phase comparator 340a, the phase of the transmit signal 618 is compared with the phase of the reference signal V_{ref-2} to determine a phase offset 606. The phase offset 606 can be represented in terms of an imaginary part Q and a real part I. The phase offset 606 is then communicated from the phase comparator 340a to the phase/amplitude controller 326a.

The reference signal V_{ref-2} utilized by the phase comparator 340a is generated by the reference signal generator 614a. The reference signal generator 614a is configured to receive sensed signals V_{f}, Vᵣ from one or more sensor devices (not shown) disposed on the optical fiber 616 at a second location different from the first location. Additionally or alternatively, the reference signal generator 614a is configured to sense signals V_{f}, Vᵣ propagated along the optical fiber 616. The sensed signals V_{f}, Vᵣ are used by the reference signal generator 614a to determine the reference signal V_{ref-2}. The manner in which the reference signal V_{ref-2} is determined is described below in relation to FIGS. 9-11. The reference signal generator 614a can be the same as or substantially similar to any one of the reference signal generator described below in relation to FIGS. 12-14. The reference signal generator 614a can also be the same as or substantially similar to the reference signal generator 614b.

The phase/amplitude controller 326a determines a phase and/or amplitude adjustment value Δw_{N} that is to be used by a beamformer 395a to adjust the phase and/or amplitude of transmit signals. The phase and/or amplitude adjustment value Δw_{N} is determined using the received phase offset 606, 626 values received from the phase comparators 340a, 332a, respectively.

As shown in FIG. 6B, the ACS 102 comprises a station frequency reference 652, a receiver 670, the hardware entities 516, 512a, the signal adder 514, the beamformer 508a, the filter 534a, a power coupler 654, a despreader 672, the phase/amplitude controller 538a, the phase comparator 536a, and a reference signal generator 654a. As also shown in FIG. 6B, the RF equipment 104a comprises the LNA 532a, a reference signal generator 654b, and a spreader 676. As further shown in FIG. 6B, the MEAS 150 comprises a ½ transmit carrier frequency device 658, an analog fiber modulator 660, an optical fiber 656, and a fiber mirror 668.

During operation, the object of interest 108 communicates a signal to the MEAS 150. The signal is received at the antenna element 106a. The antenna element 106a includes a reflector 620 with an Rx signal probe 652 disposed thereon. The Rx signal probe 652 transmits a spread reference signal 624 generated by a spreader 676. The spreader 676 is provided to ensure that the reference signal V_{ref-1} does not interfere with receive signals. The spreader 676 can be, but is not limited to, a random number spreader or a pseudo-random number spreader. The spreader 676 can receive a reference signal V_{ref-1} from the reference signal generator 654b and utilize the reference signal V_{ref-1} to generate the spread reference signal 624. More particularly, the spreader 676 can combine the reference signal V_{ref-1} with a random or pseudo-random number sequence to obtain the spread reference signal 624. Embodiments of the present invention are not limited in this regard. For example, the MEAS 150 can be absent of the spreader 676. In such a scenario, the MEAS 150 can alternatively include a frequency adjuster configured for offsetting the frequency of the reference signal V_{ref-1} by a desired amount. The desired amount can be selected for ensuring that the reference signal V_{ref-1} does not interfere with receive signals.

At the antenna element 106a, the received signal is combined with the spread reference signal 624 to form a spread spectrum signal. The spread spectrum signal is then communicated to the LNA 532a of the RF equipment 104a. The LNA 532a processes the spread spectrum signal and communicates the processed spread spectrum signal to the power coupler 654 of the ACS 102 or optional hardware entities 674.

The reference signal V_{ref-1} utilized by the spreader 676 is generated by the reference signal generator 654b. The reference signal generator 654b is configured to receive sensed signals V_{f}, Vᵣ from one or more sensor devices (not shown) disposed on the optical fiber 696 at a first location. Additionally or alternatively, the reference signal generator 654b is configured to sense signals V_{f}, Vᵣ propagated along the optical fiber 696. The sensed signals V_{f}, Vᵣ are used to determine the reference signal V_{ref-1}. The manner in which the reference signal V_{ref-1} is determined will be described below in relation to FIGS. 9-11. The reference signal generator 654b can be the same as or substantially similar to any one of the reference signal generators described below in relation to FIGS. 12-14.

At the ACS 102, the power coupler 654 receives the spread spectrum signal from the RF equipment 104a and processes the same. Thereafter, the power coupler 654 communicates the processed spread spectrum signal to the despreader 672 and the filter 534a. At the despreader 672, operations are performed with a known despreading code sequence to despread the spread spectrum signal. The dispreading code sequence can be the same as the spread reference signal 624. The despread signal is then communicated from the despreader 672 to the closed loop operator 550a.

The closed loop operator 550a is generally configured for controlling the phases and/or amplitudes of receive signals so as to counteract phasing errors due to cable delay effects, wide antenna spacing effects, and environmental effects on hardware components 102 and 104a of the communication system 100. Accordingly, the closed loop operator 550a includes a phase comparator 536a and a phase/amplitude controller 538a.

The phase comparator 536a is configured to receive a despread signal from the despreader 672 and a reference signal V_{ref-2} from a reference signal generator 654a. At the phase comparator 536a, the phase of the despread signal is compared with the phase of the reference signal V_{ref-2} to determine a phase offset 686. The phase offset 686 can be represented in terms of an imaginary part Q and a real part I. The phase offset 686 is then communicated from the phase comparator 536a to the phase/amplitude controller 538a.

The reference signal V_{ref-2} utilized by the phase comparator 536a is generated by the reference signal generator 654a. The reference signal generator 654a is configured to receive sensed signals V_{f}, Vᵣ from one or more sensor devices (not shown) disposed on the optical fiber 696 at a first location. Additionally or alternatively, the reference signal generator 654a is configured to sense signals V_{f}, Vᵣ propagated along the optical fiber 696. The sensed signals V_{f}, Vᵣ are used to determine the reference signal V_{ref-2}. The manner in which the reference signal V_{ref-2} is determined will be described below in relation to FIGS. 9-11. The reference signal generator 654a can be the same as or substantially similar to any one of the reference signal generator described below in relation to FIGS. 12-14. The reference signal generator 654a can also be the same as or substantially similar to the reference signal generator 654b described above.

The phase/amplitude controller 538a determines the complex weight w₁ that is to be used by a beamformer 508a to control the phase and/or amplitude of receive signals. The complex weight w₁ is determined using the received phase offset 686 values received from the phase comparator 536a.

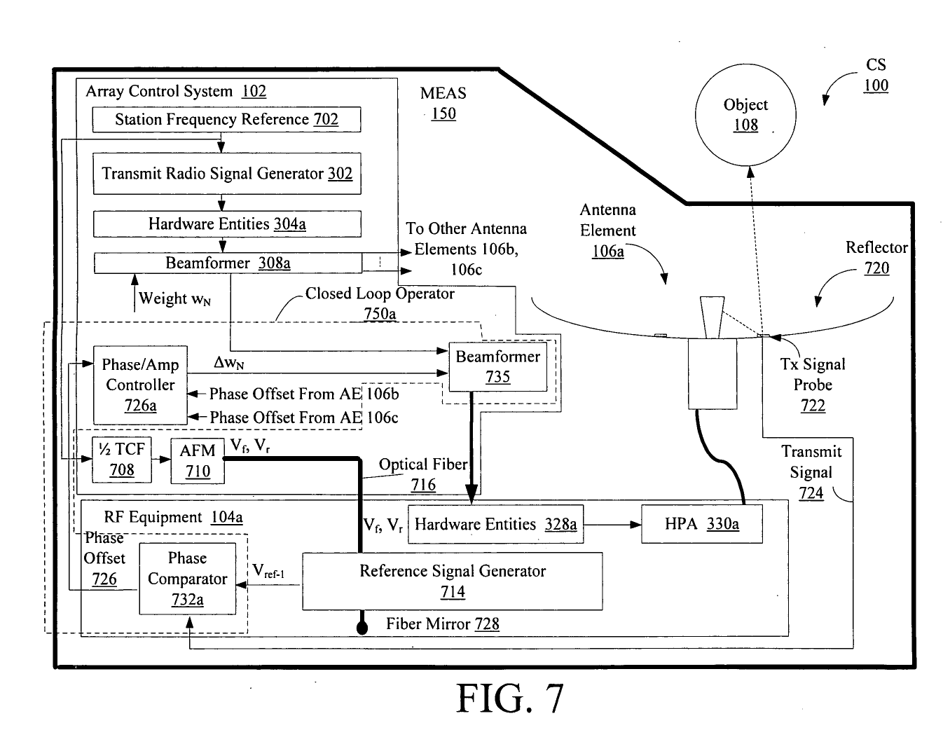

Referring now to FIG. 7, there is provided a more detailed block diagram of the communication system 100 that is useful for understanding the phase and/or amplitude adjustment functions thereof. Notably, the antenna elements 106b, 106c and RF equipment 104b, 104c are not shown in FIG. 7 to simplify the following discussion. As shown in FIG. 7, the ACS 102 comprises a station frequency reference 702, the TRSG 302, hardware entities 304a, beamformers 308a, 735, and a phase/amplitude controller 726a. As also shown in FIG. 7, the RF equipment 104a comprises hardware entities 328a, the HPA 330a, the phase comparator 732a, and a reference signal generator 714. As further shown in FIG. 7, the MEAS 150 comprises a ½ transmit carrier frequency device 708, an analog fiber modulator 710, an optical fiber 716, and a fiber mirror 728.

The TRSG 302 of the ACS 102 can generate signals to be transmitted from the antenna elements 106a, 106b (not shown), 106c (not shown). The TRSG 302 is communicatively coupled to the station frequency reference 702 and the hardware entities 304a. The hardware entities 304a are communicatively coupled to the beamformer 308a.

As noted above in relation to FIG. 3, the beamformer 308a can be utilized to control the phases and/or the amplitudes of transmit signals. Accordingly, the beamformer 308a combines a complex weight w_{N} with transmit signals to be provided to the RF equipment 904a, 904b (not shown), 904c (not shown). The beamformer 308a is communicatively coupled to the closed loop operator 750a. The closed loop operator 750 will be described below. However, it should be understood that the closed loop operator 750a is generally configured to adjust the phase and/or amplitude of transmit signals. The closed loop operator 750a is also configured to communicate the phase and/or amplitude adjusted transmit signals to the hardware entities 328a of the RF equipment 104a. The hardware entities 328a are communicatively coupled to the HPA 330a. The HPA 330a communicates processed signals to the antenna element 106a for transmission therefrom.

The closed loop operator 750a is generally configured for controlling the phases and/or amplitudes of transmit signals so as to counteract phasing errors due to cable delay effects, wide antenna spacing effects, and environmental effects on hardware components 102 and 104a of the communication system 100. Accordingly, the closed loop operator 750a includes the phase comparator 732a, a phase/amplitude controller 726a, and a beamformer 735.

The phase comparator 732a is configured to receive a transmit signal 724 from the antenna element 106a and a reference signal V_{ref-1} from a reference signal generator 714. In this regard, it should be understood that the antenna element 106a has a transmit (Tx) signal probe 722 disposed on its reflector 720 for sensing the transmit signal 724. At the phase comparator 732a, the phase of the sensed transmit signal 724 is compared with the phase of the reference signal V_{ref-1} to determine a phase offset 726. The phase offset 726 can be represented in terms of an imaginary part Q and a real part I. The phase offset 726 is then communicated from the phase comparator 732a to the phase/amplitude controller 726a.

The reference signal V_{ref-1} utilized by the phase comparator 732a is generated by the reference signal generator 714. The reference signal generator 714 is configured to receive sensed signals V_{f}, Vᵣ from one or more sensor devices (not shown) disposed on the optical fiber 716 at a first location. Additionally or alternatively, the reference signal generator 714 is configured to sense signals V_{f}, Vᵣ propagated along the optical fiber 716. The sensed signals V_{f}, Vᵣ are used to determine the reference signal V_{ref-1}. The manner in which the reference signal V_{ref-1} is determined will be described below in relation to FIGS. 9-11. The reference signal generator 714 can be the same as or substantially similar to any one of the reference signal generators described below in relation to FIGS. 12-14.

The phase/amplitude controller 726a is configured for receiving phase offsets from each of the RF equipments 104a, 104b (not shown), 104c (not shown). The phase/amplitude controller 726a determines a phase and/or amplitude adjustment value Δw_{N} that is to be used by a beamformer 735 to adjust the phase and/or amplitude of transmit signals. The phase and/or amplitude adjustment value Δw_{N} is determined using the received phase offset 606 values received from the RF equipments 104a, 104b (not shown), 104c (not shown).

FIG. 8 is a schematic diagram of a computer system 800 for executing a set of instructions that, when executed, can cause the computer system to perform one or more of the methodologies and procedures described above. For example, a computer system 800 can be implemented to perform the various tasks of the transmit side 202 and/or the receive side 204 the ACS 102. In some embodiments, the computer system 800 operates as a single standalone device. In other embodiments, the computer system 800 can be connected (e.g., using a network) to other computing devices to perform various tasks in a distributed fashion. In a networked deployment, the computer system 800 can operate in the capacity of a server or a client machine in server-client network environment, or as a peer machine in a peer-to-peer (or distributed) network environment.

The computer system 800 can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 800 can include a processor 802 (such as a central processing unit (CPU), a graphics processing unit (GPU, or both), a main memory 804 and a static memory 806, which communicate with each other via a bus 808. The computer system 800 can further include a display unit 810, such as a video display (e.g., a liquid crystal display or LCD), a flat panel, a solid state display, or a cathode ray tube (CRT)). The computer system 800 can include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 can include a computer-readable storage medium 822 on which is stored one or more sets of instructions 824 (e.g., software code) configured to implement one or more of the methodologies, procedures, or functions described herein. The instructions 824 can also reside, completely or at least partially, within the main memory 804, the static memory 806, and/or within the processor 802 during execution thereof by the computer system 800. The main memory 804 and the processor 802 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 824 or that receives and executes instructions 824 from a propagated signal so that a device connected to a network environment 826 can send or receive data, and that can communicate over the network 826 using the instructions 824. The instructions 824 can further be transmitted or received over a network 826 via the network interface device 820.

While the computer-readable storage medium 822 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

As noted above, the cable assemblies 110a, 110b, 110c and the communication links 118a, 118b, 118c (or 119a, 119b, 119c) of the communication system 100 delay signals between the ACS 102 and the antenna elements 106a, 106b, 106c. In effect, the phases of the signals are shifted thereby resulting in phasing errors. Such phasing errors are exacerbated by the spacing between the antenna elements 106a, 106b, 106c. Phasing errors also occur as a result of environmental effects on the hardware components 102, 104a, 104b, 104c of the communication system 100. Phasing errors further occur as a result of operation delays between the beamformers 308a, 308b, 308c or operation delays between beamformers 408a, 408b, 408c. The accumulated phasing errors inhibit desirable or adequate beam formation, i.e., the accumulated phasing errors can result in the steering of the radiated central beam 112 in a direction other than the direction 116 of the object of interest 108.

Accordingly, the communication system 100 implements a method for adjusting the phases and/or amplitudes of signals transmitted from and received at each antenna element 106a, 106b, 106c. The phases and/or amplitudes of the transmit and receive signals are adjusted using a plurality of reference signals V_{ref}. The reference signals V_{ref} generally represent transmitted signals absent of phase shifts. A first one of the reference signals V_{ref} is compared with a signal having phase shifts for determining a phase offset between the same. The phase offset and a second one of the reference signals V_{ref} are then used to control the phase and/or amplitude of a transmit and/or receive signal so as to counteract phasing errors due to cable delay effects, wide antenna spacing effects, and environmental effects on hardware components 102, 104a, 104b, 104c of a communication system 100. More particularly, the phase offset and a second one of the reference signals V_{ref} are used to determine the complex weights w₁, w₂, w₃ that are subsequently combined with transmit and/or receive signals. Systems and methods for determining the reference signals V_{ref} will now be described in relation to FIGS. 9-14.

### Systems and Methods for Determining Reference Signals V_{ref}

Referring now to FIG. 9, there is provided a block diagram of a communication system 900 that is useful for understanding how a reference signal V_{ref} is determined. As shown in FIG. 9, the communication system 900 can comprise a signal source 902, a sensor 916, a reflective termination 914, and a non-reflective termination 904. Each of these components 902, 904, 914, 916 is well known to those having ordinary skill in the art, and therefore will not be described in detail herein. However it should be understood that in order to determine a reference signal V_{ref}, a forward propagated signal V_{f} and a reverse propagated signal Vᵣ need to be sensed at a location “z” along the transmission media 908. As such, the signal source 902 generally transmits a signal V_{f} to the reflective termination 914. A reflected version of the transmitted signal Vᵣ is communicated from the reflective termination 914 to the non-reflective termination 904. The sensor 916 senses the presence of a forward propagated signal V_{f} and a reverse propagated signal Vᵣ on the transmission media 908. The sensor 916 may also adjust the gain of the signals V_{f}, Vᵣ so that they have equal arbitrarily defined amplitudes “a”. This gain adjustment can involve performing Automatic Gain Control (AGC) operations which are well known to those having ordinary skill in the art. Thereafter, the sensor 916 outputs signals representing the forward propagated signal V_{f} and the reverse propagated signal Vᵣ. These output signals can subsequently be used to compute the reference signal V_{ref}.

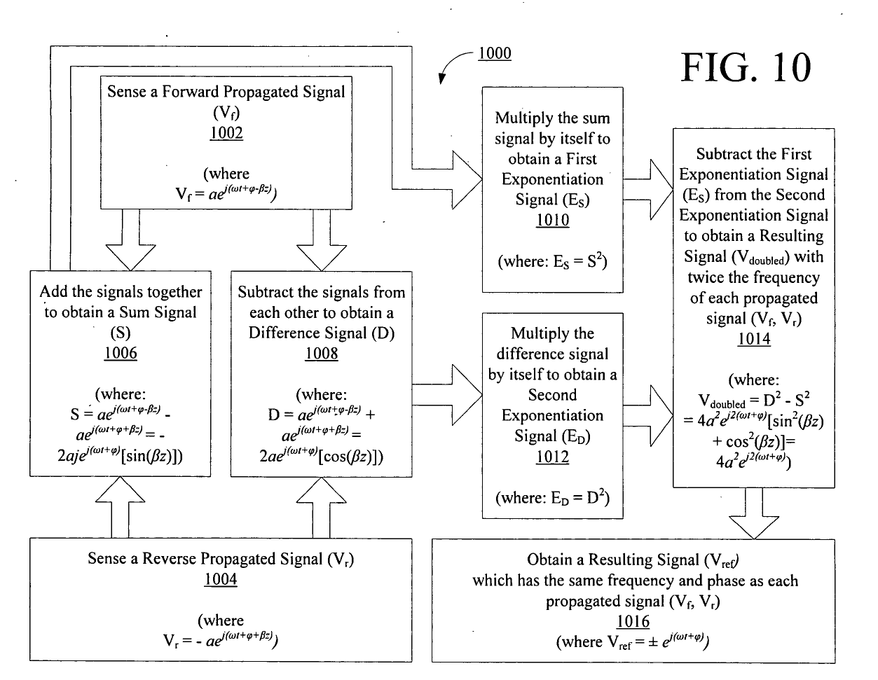

A conceptual diagram of a first exemplary process 1000 for determining the reference signal V_{ref} is provided in FIG. 10. As shown in FIG. 10, the process 1000 begins by (1002, 1004) sensing a forward propagated signal V_{f} and a reverse propagated signal Vᵣ. It should be appreciated that the sensing processes (1002, 1004) can involve gain adjustments as necessary so that the resulting signals have an arbitrarily defined amplitude a. The gain adjustments can involve performing AGC operations. The forward propagated signal V_{f} can be defined by the following mathematical equation (1). Similarly, the reverse propagated signal Vᵣ, for the exemplary case of a short circuit reflection, can be defined by the following mathematical equation (2).

V_{f}=ae^{j(ωt+φ-βz)} (1)

Vᵣ=ae^{j(ωt+φ+βz)} (2)

where a is signal amplitude. j is the square root of minus one (j=(−1)^{1/2}). ω is a radian frequency. φ is a phase angle. β is a wave number that is equal to 2π/λ, where λ is a wavelength. z is a location along a transmission media.

Thereafter, a signal combination operation 1006 is performed where the signals V_{f}, Vᵣ are combined to obtain a Sum signal (S). This signal combination operation 1006 generally involves adding the signals V_{f}, Vᵣ together. The signal combination operation 1006 can be defined by the following mathematical equation (3).

S=ae^{j(ωt+φ-βz)}−ae^{j(ωt+φ+βz)}=−2aje^{j(ωt+φ)}[sin(βz)] (3)

As evident from mathematical equation (3), the Sum signal S is a sine signal that depends on the location “z” at which the sensor 916 is placed along the transmission media 908.

The process 1000 also involves performing a subtraction operation 1008. The subtraction operation 1008 generally involves subtracting the reverse propagated signal Vᵣ from the forward propagated signal V_{f} to obtain a Difference signal (D). The subtraction operation 1008 can be defined by the following mathematical equation (4).

D=ae^{j(ωt+φ-βz)}+ae^{j(ωt+φ+βz)}=2ae^{j(ωt+φ)}[cos(βz)] (4)

As evident from mathematical equation (4), the Difference signal D is a cosine signal that depends on the location “z” at which the sensor 916 is placed along the transmission media 908.

After determining the Sum signal S and the Difference signal D, the process 1000 continues with a plurality of multiplication operations 1010, 1012. A first one of the multiplication operations 1010 generally involves multiplying the Sum signal S by itself to obtain a first Exponentiation signal E_{S}. The first multiplication operation 1010 can generally be defined by the following mathematical equation (5).

E_{S}=S·S=S² (5)

where E_{S} is the first Exponentiation signal. S is the Sum signal. S² is the Sum signal S raised to the second power.

A second one of the multiplication operations 1012 generally involves multiplying the Difference signal D by itself to obtain a second Exponentiation signal E_{D}. The second multiplication operation 1012 can generally be defined by the following mathematical equation (6).

E_{D}=D·D=D² (6)

where E_{D} is the second Exponentiation signal. D is the Difference signal. D² is the Difference signal D raised to the second power.

Subsequent to determining the first and second Exponentiation signals, the process continues with a subtraction operation 1014. The subtraction operation 1014 generally involves subtracting the first Exponentiation signal E_{S} from the second Exponentiation signal E_{D}. The subtraction operation 1014 can be defined by the following mathematical equation (7).

V_{doubled}=D²−S²=4a²e^{j2(ωt+φ)}[sin²(βz)+cos²(βz)]=4a²e^{j2(ωt+φ)} (7)

where V_{doubled} represents the signal obtained as a result of performing the subtraction operation 1014. As evident from mathematical equation (7), the resulting signal V_{doubled} does not depend on the location “z” at which the sensor 916 is placed along the transmission media 908. The resulting signal V_{doubled} has twice the frequency relative to that of each propagated signal V_{f}, Vᵣ. As such, the resulting signal V_{doubled} is further processed to increase its frequency to a desired value or reduce its frequency to a desired value (i.e., the value of the frequency of a propagated signal V_{f}, Vᵣ). If the frequency of the resulting signal V_{doubled} is to be increased to the desired value, then a multiplication operation (not shown) can be performed. If the frequency of the resulting signal V_{doubled} is to be reduced to the desired value, then a frequency reduction operation 1016 can be performed.

The frequency reduction operation 1016 can generally involve performing a phase locked loop operation and a frequency division operation. Phase locked loop operations are well known to those having ordinary skill in the art, and therefore will not be described herein. The frequency division operation can involve dividing the frequency of the resulting signal V_{doubled} by two (2). The output signal from the frequency reduction operation is the reference signal V_{ref}. The reference signal V_{ref} can be defined by the following mathematical equation (8):

V_{ref}=±e^{j(ωt+φ)} (8)

for any line position “z”. As evident from mathematical equation (8), the reference signal V_{ref} is a signal that does not depend on the location “z” at which the sensor 916 is placed along the transmission media 908. As such, the reference signal V_{ref} can be determined at one or more locations along a transmission media. This location “z” independence is a significant and highly desirable result.

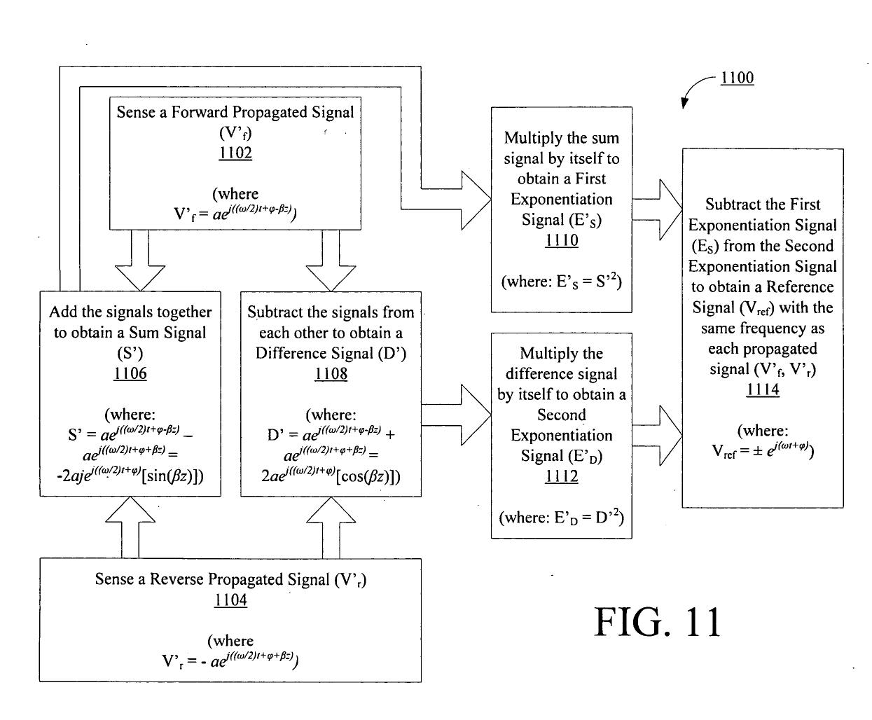

Embodiments of the present invention are not limited to the process 1000 described above in relation to FIG. 10. For example, if the frequency of each propagated signal V_{f}, Vᵣ is reduced by exactly half, then the frequency reduction operation 916 need not be performed. A conceptual diagram of a process 1100 for determining the reference signal V_{ref} absent of the frequency reduction operation 1016 is provided in FIG. 11. The propagated signals with half the frequency of the signals V_{f}, Vᵣ is referred to herein as V′_{f}, V′ᵣ, respectively.

As shown in FIG. 11, the process 1100 generally involves performing sensing operations 1102, 1104 to sense propagated signals V′_{f}, V′ᵣ, a signal combination operation 1106, a subtraction operations 1108, 1114, and multiplication operations 1110, 1112. These listed operations 1102, 1104, . . . , 1114 are the same as or substantially similar to the operations 1002, 1004, . . . , 1014 of FIG. 10, respectively. As such, the operations 1102, 1104, . . . , 1114 of process 1100 will not be described herein.

Referring now to FIG. 12, there is provided a block diagram of a first exemplary system 1200 implementing a method for determining a reference signal V_{ref}, V′_{ref}. As shown in FIG. 12, the system 1200 comprises a sensing device 1202, a signal adder 1206, signal subtractors 1208, 1214, and signal multipliers 1210, 1212. The system 1200 can also comprise an optional phase lock loop 1216 and an optional frequency divider 1218. The sensing device 1202 is generally configured for sensing the presence of a forward propagated signal V_{f} or V′_{f} and a reverse propagated signal Vᵣ or V′ᵣ on the transmission media 908. The sensing device 1202 may also adjust the gain of the signals V_{f} or V′_{f}, Vᵣ or V′ᵣ so that they have equal arbitrarily defined amplitudes “a”. This gain adjustment can involve performing AGC operations. The sensing device 1202 can also generate output signals representing the forward propagated signal V_{f} or V′_{f} and the reverse propagated signal Vᵣ or V′ᵣ. These output signals can subsequently be used to compute the signal V_{doubled} and/or the reference signal V_{ref}. As such, the sensing device 1202 can further communicate the signals representing the forward propagated signal V_{f} or V′_{f} and the reverse propagated signal Vᵣ or V′ᵣ to the following components 1206, 1208.

The signal adder 1206 is generally configured for performing a signal combination operation 1006, 1106 to obtain a Sum signal S or S′. The signal subtractor 1208 is generally configured for performing a subtraction operation 1008, 1108 to obtain a Difference signal D or D′. The output signals of the components 1206, 1208 are forwarded to the signal multipliers 1210, 1212. Each of the multipliers 1210, 1212 is configured to perform a multiplication operation 1010, 1012, 1110, 1112 to obtain a respective Exponentiation signal E_{S}, E′_{S}, E_{D}, E′_{D}. The Exponentiation signals E_{S} and E_{D} or E′_{S} and E′_{D} are then communicated to the signal subtractor 1214. At the signal subtractor 1214, a subtraction operation 1014, 1114 is performed to obtain a signal V_{doubled} or a reference signal V_{ref}.

If the result of the subtraction operation is a signal V_{doubled}, then the signal V_{doubled} can be further processed to reduce the value of its frequency. In such a scenario, the signal V_{doubled} is forwarded to an optional phase lock loop 1216 and an optional frequency divider 1218. The components 1216, 1218 collectively act to reduce the frequency of the signal V_{doubled} to a desired value (i.e., the value of the frequency of a propagated signal V_{f}, Vᵣ). The output of the frequency divider 1218 is the reference signal V_{ref}.

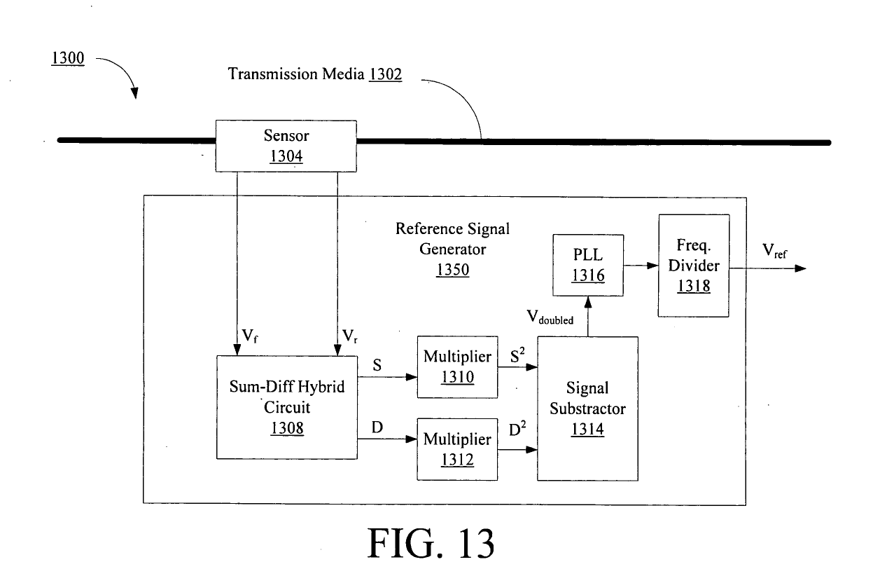

Referring now to FIG. 13, there is provided a block diagram of a second exemplary system 1300 implementing a method for determining a reference signal V_{ref}. As shown in FIG. 13, the system 1300 comprises a sensing device 1304 disposed along a transmission media 1302 and a reference signal generator 1350. The reference signal generator 1350 comprises a sum-diff hybrid circuit 1308, multipliers 1310, 1312, a signal subtractor 1314, a phase lock loop (PLL) 1316, and a frequency divider 1318. Embodiments of the present invention are not limited to the configuration shown in FIG. 13. For example, the reference signal generator 1350 can be absent of the PLL 1316 and the frequency divider 1318.

The sensing device 1304 is generally configured for sensing the presence of a forward propagated signal V_{f} and a reverse propagated signal Vᵣ on the transmission media 1302. The sensing device 1304 may also adjust the gain of the signals V_{f}, Vᵣ so that they have equal arbitrarily defined amplitudes “a”. This gain adjustment can involve performing AGC operations. The sensing device 1304 can also generate output signals representing the forward propagated signal V_{f} and the reverse propagated signal Vᵣ. These output signals can subsequently be used to compute the reference signal V_{ref}. As such, the sensing device 1302 can further communicate the signals representing the forward propagated signal V_{f} and the reverse propagated signal Vᵣ to the sum-diff hybrid circuit 1308.

The sum-diff hybrid circuit 1308 is generally configured for performing a signal combination operation 1006 to obtain a Sum signal S and a subtraction operation 1008 to obtain a Difference signal D. Subsequent to completing the signal combination operation and subtraction operation, the sum-diff hybrid circuit 1308 communicates the signals S and D to the multipliers 1310, 1312, respectively. Each of the multipliers 1310, 1312 is configured to perform a multiplication operation 1010, 1012 to obtain a respective Exponentiation signal E_{S}, E_{D}. The Exponentiation signals E_{S}, E_{D} are then communicated to the signal subtractor 1314. At the signal subtractor 1314, a subtraction operation 1014 is performed to obtain a signal V_{doubled}. The signal V_{doubled} is then processed by the PLL 1316 and frequency divider 1318 to reduce the frequency of the signal V_{doubled} to a desired value (i.e., the value of the frequency of a propagated signal V_{f}, Vᵣ). The output of the frequency divider 1318 is the reference signal V_{ref}.

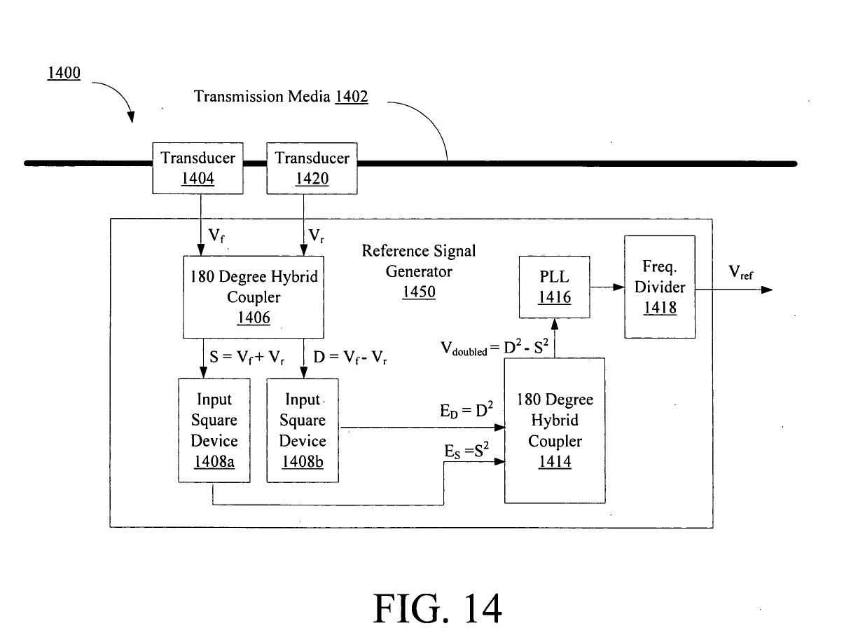

Referring now to FIG. 14, there is provided a block diagram of a third system embodiment 1400 implementing the method of FIG. 10. As shown in FIG. 14, the system 1400 comprises transducers 1404, 1420 and a reference signal generator 1450. Transducers are well known to those having ordinary skill in the art, and therefore will not be described herein. However, it should be understood that each of the transducers 1404, 1420 is configured to communicate a signal representing a signal V_{f}, Vᵣ propagated on the transmission media 1402 to the reference signal generator 1450.

As also shown in FIG. 14, the reference signal generator 1450 comprises 180 degree hybrid couplers 1406, 1414, input square devices 1408a, 1408b, a PLL 1416, and a frequency divider 1418. Embodiments of the present invention are not limited to the configuration shown in FIG. 14. For example, the reference signal generator 1450 can be absent of the PLL 1416 and the frequency divider 1418.

Hybrid couplers 1406 are well known to those having ordinary skill in the art, and therefore will not be described herein. However, it should be understood that the hybrid coupler 1406 generates signals representing the Sum signal S and the Difference signal D. The generated signals S and D are then communicated from the hybrid coupler 1406 to the input square devices 1408a, 1408b, respectively. Each of the input square devices 1408a, 1408b generates a respective Exponentiation signal E_{S}, E_{D}. The Exponentiation signals E_{S}, E_{D} are communicated from the input square devices 1308a, 1408b to the hybrid coupler 1414. The hybrid coupler 1414 performs a subtraction operation 1014 to obtain a signal V_{doubled}.

Next, the signal V_{doubled} is further processed to reduce the value of its frequency. Accordingly, the signal V_{doubled} is forwarded from the hybrid coupler 1414 to the PLL 1416 and the frequency divider 1418. The components 1416, 1418 collectively act to reduce the frequency of the signal V_{doubled} to a desired value (i.e., the value of the frequency of a propagated signal V_{f}, Vᵣ).

In light of the forgoing description of the invention, it should be recognized that the present invention can be realized in hardware, software, or a combination of hardware and software. A method for determining a reference signal V_{ref} according to the present invention can be realized in a centralized fashion in one processing system, or in a distributed fashion where different elements are spread across several interconnected processing systems. Any kind of computer system, or other apparatus adapted for carrying out the methods described herein, is suited. A typical combination of hardware and software could be a general purpose computer processor, with a computer program that, when being loaded and executed, controls the computer processor such that it carries out the methods described herein. Of course, an application specific integrated circuit (ASIC), and/or a field programmable gate array (FPGA) could also be used to achieve a similar result.

Applicants present certain theoretical aspects above that are believed to be accurate that appear to explain observations made regarding embodiments of the invention. However, embodiments of the invention may be practiced without the theoretical aspects presented. Moreover, the theoretical aspects are presented with the understanding that Applicants do not seek to be bound by the theory presented.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A method for compensating for phase shifts of a communication signal, comprising:
determining a first reference signal at a first location along a transmission path and a second reference signal at a second location along the transmission path, the second reference signal having the same phase as the first reference signal;
determining at the first location a first phase offset using the first reference signal and a first communication signal;
determining at the second location a second phase offset using the second reference signal and a second communication signal; and
adjusting at the second location a phase of a third communication signal using the first and second phase offsets to obtain a modified communication signal;
wherein the first, second, and third communication signals are the same communication signal obtained at different locations along the transmission path.

2. The method according to claim 1, wherein the first phase offset is determined by comparing at the first location a first phase of the first communications signal by a second phase of the first reference signal and the second phase offset is determined by comparing at the second location a third phase of the second communications signal by a fourth phase of the second reference signal.

3. The method according to claim 1, wherein the adjusting step comprises determining a phase adjustment value for reducing a difference between the first and second phase offsets.

4. The method according to claim 1, wherein the adjusting step comprises computing a correction weight at the second location using the first and second phase offsets and combining the correction weight with the third communication signal to obtain the modified communication signal.

5. The method according to claim 1, further comprising filtering the first communications signal prior to determining the first phase offset.

6. The method according to claim 1, wherein the step of determining the first reference signal comprises
sensing at the first location a transmit signal propagated over a transmission media in a forward direction and a reverse signal propagated over the transmission media in a reverse direction opposed from the forward direction, the reverse signal being a reflected version of the transmit signal;
computing a first sum signal by adding the transmit and reverse signals together and a first difference signal by subtracting the reverse signal from the transmit signal;
computing a first exponentiation signal using the first sum signal and a second exponentiation signal using the first difference signal; and
subtracting the first exponentiation signal from the second exponentiation signal to obtain the first reference signal.

7. The method according to claim 6, wherein the first reference signal has a first frequency equal to a second frequency of the transmit signal.

8. The method according to claim 6, wherein the first reference signal has a first frequency different than a second frequency of the transmit signal.

9. The method according to claim 8, further comprising processing the first reference signal to obtain an adjusted reference signal with a third frequency equal to the second frequency of the transmit signal.

10. The method according to claim 6, wherein the step of determining the second reference signal comprises
sensing at the second location the transmit and reverse signals; and
computing the second reference signal using the transmit and reverse signals sensed at the second location.

11. The method according to claim 10, wherein the second reference signal is further determined by
computing a second sum signal by adding the transmit and reverse signals sensed at the second location together and a second difference signal by subtracting the reverse signal sensed at the second location from the transit signal sensed at the second location;
computing a third exponentiation signal using the second sum signal and a fourth exponentiation signal using the second difference signal; and
subtracting the third exponentiation signal from the fourth exponentiation signal to obtain the second reference signal.

12. The method according to claim 1, further comprising transmitting the modified communication signal to an object of interest.

13. A method for compensating for phase shifts of a communication signal, comprising:
determining a first reference signal at a first location along a transmission path and a second reference signal at a second location along the transmission path, the second reference signal has the same phase as the first reference signal;
combining at the first location the communication signal with the first reference signal to obtain a modified communication signal;
determining at the second location a phase offset using the modified communication signal and the second reference signal; and
adjusting at the second location a phase of a modified communication signal using the phase offset to obtain a phase adjusted communication signal.

14. The method according to claim 13, further comprising modifying a frequency of the first reference signal prior to combining the first reference signal with the communication signal.

15. The method according to claim 13, further comprising combining the first reference signal with a random or pseudo-random number sequence prior to combining the first reference signal with the communication signal.

16. A system, comprising:
at least one reference signal generator configured for determining a first reference signal at a first location along a transmission path and a second reference signal at a second location along the transmission path, the second reference signal has the same phase the first reference signal; and
at least one closed loop operator communicatively coupled to the reference signal generator and configured for determining at the first location a first phase offset using the first reference signal and a first communication signal, determining at the second location a second phase offset using the second reference signal and a second communication signal, and adjusting at the second location a phase of a third communication signal using the first and second phase offsets to obtain a modified communication signal;
wherein the first, second, and third communication signals are the same communication signal obtained at different locations along the transmission path.

17. The system according to claim 16, wherein the closed loop operator is further configured for determining a phase adjustment value for reducing the first and second phase offsets.

18. The system according to claim 16, wherein the closed loop operator is further configured for computing a weight at the second location using the first and second phase offsets and combining the weight with the third communication signal to obtain the modified communication signal.

19. The system according to claim 16, further comprising:
at least one sensing device configured for sensing at the first location a transmit signal propagated over a transmission media in a forward direction and a reverse signal propagated over the transmission media in a reverse direction opposed from the forward direction, the reverse signal being a reflected version of the transmit signal; and
a first reference signal generator communicatively coupled to the sensing device and configured for computing a sum signal by adding the transmit and reverse signals together, computing a difference signal by subtracting the reverse signal from the transmit signal, computing a first exponentiation signal using the sum signal, computing a second exponentiation signal using the difference signal, and subtracting the first exponentiation signal from the second exponentiation signal to obtain the first reference signal.

20. The system according to claim 17, wherein the first reference signal has a first frequency equal to a second frequency of the transmit signal.

21. The system according to claim 17, wherein the first reference signal has a first frequency different than a second frequency of the transmit signal.

22. The system according to claim 21, wherein the first reference signal generator is further configured for processing the first reference signal to obtain an adjusted reference signal with a third frequency equal to the second frequency of the transmit signal.

23. The system according to claim 16, further comprising
at least one sensing device configured for sensing at the second location the transmit and receive signals; and
a second reference signal generator communicatively coupled to the sensing device and configured for computing the second reference signal using the transmit and reverse signals sensed at the second location.

24. The system according to claim 23, wherein the second reference signal generator is further configured for
computing a sum signal by adding the transmit and reverse signals sensed at the second location together and a difference signal by subtracting the reverse signal sensed at the second location from the transmit signal sensed at the second location;
computing a first exponentiation signal using the sum signal and a second exponentiation signal using the difference signal; and
subtracting the first exponentiation signal from the second exponentiation signal to obtain the second reference signal.
